(19) United States
(12) Patent Application Publication
(10) Pub. No.: US 2010/0258685 A1
(43) Pub. Date: Oct. 14, 2010

(54) UTILITY HOLDER

(76) Inventors: Michael J. Gardner, Hudson, OH (US); Glenn A. Baker, Cleveland, OH (US)

Correspondence Address: Emerson, Thomson & Bennett, LLC, 1914 Akron-Peninsula Road, Akron, OH, 44313, US

(21) Appl. No.: 12/760,059

(22) Filed: Apr. 14, 2010

Related U.S. Application Data
(60) Provisional application No. 61/169,136, filed on Apr. 14, 2009.

(51) Int. Cl. F16L 3/22; B23P 19/04

(52) U.S. Cl. 248/68.1; 29/700

(57) ABSTRACT

A utility holder which may be used to retain utility lines may include a holder having a first portion having at least two pairs of fingers defining at least two receiving sections wherein the receiving sections may be sized to accept utility lines; a second portion having a base wherein the pairs of fingers extend from the base with the longitudinal axes of the receiving sections being substantially parallel.

This application claims priority to U.S. Ser. No. 61/169,136, entitled UTILITY HOLDER, filed Apr. 14, 2009, which is incorporated herein by reference.

### BACKGROUND

A. Field of Invention

This invention generally relates to methods and apparatuses concerning installation of utility lines and more specifically relates to methods and apparatuses concerning holders for utility lines.

B. Description of the Related Art

It is well known to utilize clamping or holding devices to secure utility lines to structural surfaces of buildings or support members of a frame. The prior art holding devices include U-shaped clamps made from elastic sheet metal that are secured over positioned utility lines or cables, and in some instances “open-profile” devices that are secured to the support surface before accepting utility lines, but the most commonly used holding devices are common heavy duty staples. Even the more complicated prior art holding devices come only in predetermined configurations to hold a single utility line. It is often the situation where it is necessary to secure several parallel utility lines to the same surface. It is inefficient and more costly to install multiple individual holders to retain several utility lines. Additionally it requires more installation space to use multiple holders and space is often limited.

Known attempted solutions to this problem include requiring the person installing utility lines to carry a variety of holders to match the number of utility lines or to combine individual holders to obtain a configuration that meets the installation requirements.

What is needed is a utility holder that can be easily configured at the installation site to hold the required number of utility lines. The desired holder should be simpler to install and have lower installation costs than the known holders.

### SUMMARY

According to one embodiment of this invention, a utility holder assembly may comprise a holder comprising a first portion having at least two pairs of fingers defining at least two receiving sections wherein the receiving sections may be sized to accept utility lines and a second portion having a base wherein the pairs of fingers extend from the base with the longitudinal axes of the receiving sections being substantially parallel.

According to another embodiment of this invention, a utility holder array may comprise a first holder comprising: a first portion having at least two pairs of fingers defining at least two receiving sections wherein the receiving sections may be sized to accept utility lines; a second holder substantially similar to the first holder including the first portion; and, a base wherein the fingers of the first and second holders extend in a substantially perpendicular manner from the base, additionally the longitudinal axes of the first holder and second holder receiving sections are aligned in substantially a straight line.

According to yet another embodiment of this invention, a method may comprise the steps of: (A) providing a holder comprising: (1) a first portion having at least two pairs of fingers defining at least two receiving sections wherein the receiving sections may be sized to accept utility lines; and, (2) a second portion having a base wherein the pairs of fingers extend from the base with the longitudinal axes of the receiving sections being substantially parallel; (B) providing a second holder substantially similar to first holder including the first and second portions; (C) attaching the base of the first holder to a structure; (D) attaching the base of the second holder to a structure such that longitudinal axis of the first receiving section of the first holder and the longitudinal axis of the first receiving section of the second holder align in substantially a straight line; (E) inserting a section of a first utility line into the first receiving section of the first holder; (F) inserting a second continuous section of the first utility line into the first receiving section in the second holder that lies in a substantially straight line from the first holder; (G) inserting a section of a second utility line into the second receiving section of the first holder; and, (H) inserting a second continuous section of the second utility line into the second receiving section in the second holder that lies in a substantially straight line from the first holder.

One advantage of this invention is that a utility holder assembly can retain multiple utility lines within a single utility holder.

Another advantage of this invention is that a utility holder assembly can easily be configured so that the holder's receiving sections matches the number of utility lines that must be retained.

Yet another advantage of this invention is that a utility holder assembly used to retain multiple utility lines can be installed in a simple and economic manner.

Yet another advantage of the present invention is that it provides stronger retention properties than known open-profile utility holders.

Still other benefits and advantages of the invention will become apparent to those skilled in the art to which it pertains upon a reading and understanding of the following detailed specification.

### BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a perspective view of a row of utility holders in accordance with a first embodiment

FIG. 2 is an end view of the row of FIG. 1.

FIG. 3 is a top (or plan) view of the row of FIG. 1.

FIG. 4 is a front view of the row of FIG. 1.

FIG. 5 is a perspective view of a row of utilities holders in accordance with a second embodiment shown holding a variety of utility lines.

FIG. 6 is an array of utility holders in accordance with a third embodiment.

FIG. 7 is a perspective view of a utility line installation including a number of the utility holders of FIG. 6.

FIGS. 8a and 8b are perspective and side views, respectively, showing the shape of the utility holder's receiving sections according to one embodiment of the invention.

FIGS. 9a, 9b, 9c, and 9d are perspective, side, top, and operational views, respectively, of the utility holder according to one embodiment of the invention.

### DETAILED DESCRIPTION

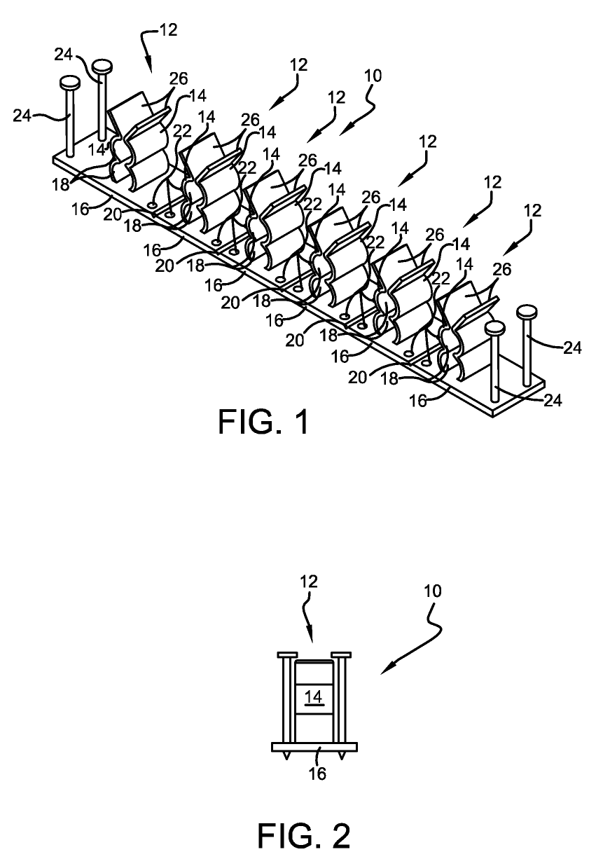

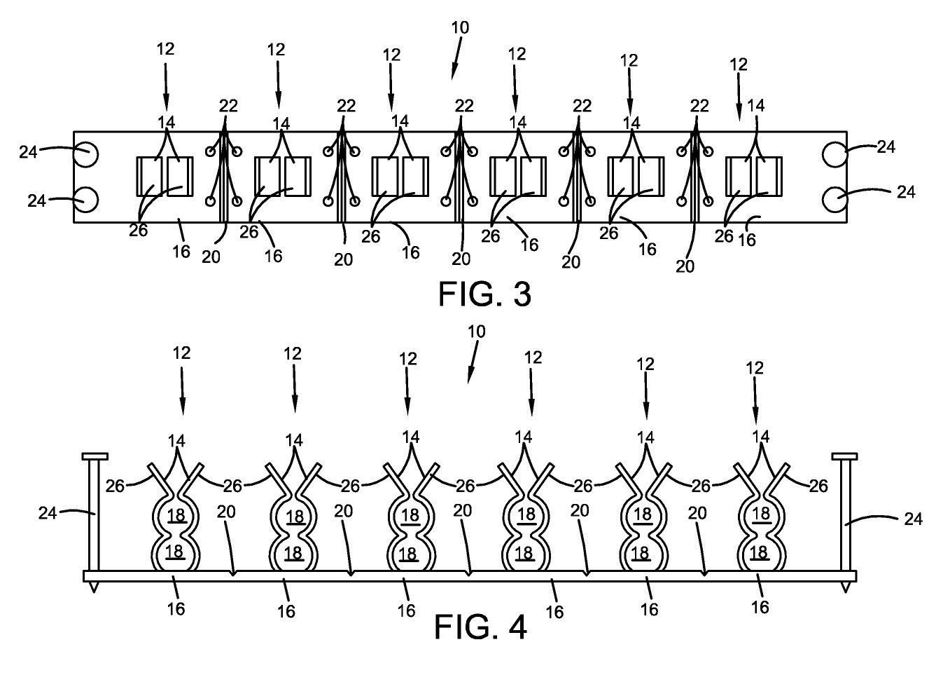

Referring now to the drawings wherein the showings are for purposes of illustrating embodiments of the invention only and not for purposes of limiting the same, and wherein like reference numerals are understood to refer to like components, FIGS. 1-4 shows a row 10 of utility holders 12 in accordance with a first embodiment. The row 10 includes six holders 12, but may include any desired number. Each utility holder 12 includes at least two pairs of fingers 14 extending from a base 16. Each pair of fingers 14 defines at least one receiving section 18. Each receiving section 18 is suitable to hold a utility line such as, but not limited to, a high or low voltage electrical cable, electrical conduit, plumbing supply or drain lines, HVAC lines, and the like. For example, some non limiting examples of acceptable cable include: traditional AC/MC cable (of various sizes, including but not limited to, 14-2, 12-2, and 14-3); non-metallic sheathed cable (“NM” cable of various sizes, including but not limited to, 14-2, 14-3, 14-4, 12-2, 12-3, 12-4, 10-2, and 10-3); MC cable (including, but not limited to, MC-AP type in size 14-2, 14-3, 12-2, 12-3, and 10-2); any low voltage cable, including but not limited to, Category (“Cat”) 3, 4, 5 and 6 cable, RG6 (coaxial or “co-ax”) cable, speaker wire, fire alarm, and USB cables; and composite cables (including but not limited to, for example, varying combinations of Cat5e/Cat6+Coaxial+Fiber). The utility holders 12, and their respective fingers 14 and receiving sections 18, may be compliant with UL Standard 2239 in that they are capable of securely retaining an associated cable subjected to a fifty pound pullout for a five minute period.

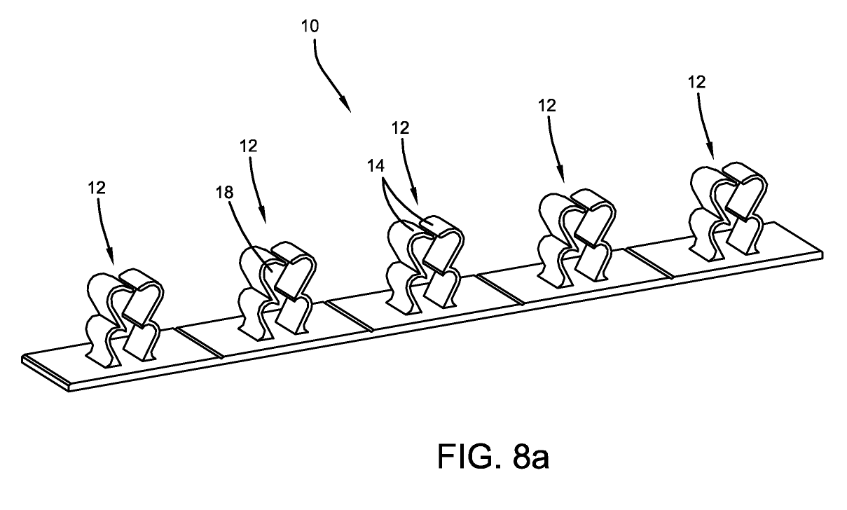

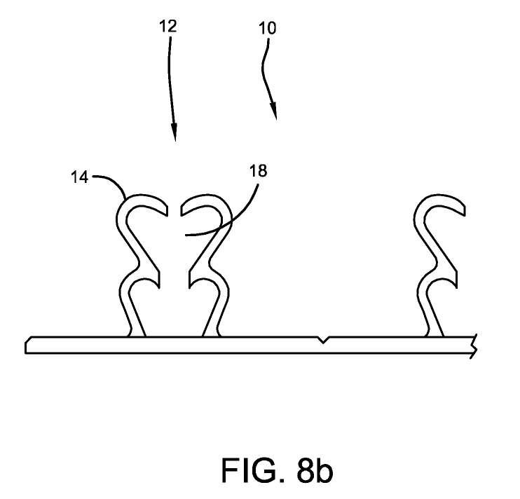

Each pair of fingers 14 FIGS. 1-4 is shown as defining two receiving sections 18. It must be understood, however, that the holder 12 may include any suitable number of receiving sections defined by any suitable number of fingers or other receiving section defining elements. The two receiving sections 18 shown in FIGS. 1-4 are two similar sized sections for receiving round electrical conduit, plumbing lines or other round lines. It must be understood, however, that the receiving sections 18 may be sized differently, as to accept lines of different size. Further, the fingers 14, and in turn the receiving sections 18 defined by the fingers 14, may be shaped differently, as to accept lines of different shapes (e.g. round 3 conductor NM cable and flat 2 conductor NM cable), or to impart additional structural integrity. As generally illustrated in FIGS. 8a and 8b, the shape of the fingers 14, and the receiving sections 18 defined by the fingers 14, can be of varying configuration; instead of the round receiving sections 18 of FIGS. 1-4, the shape of receiving sections in other embodiments of the invention can be, by way of non-limiting examples shown in FIGS. 8a and 8b, a substantially heart-shaped design designed to act as a barb that permits easy insertion while simultaneously providing stronger structural support properties and reducing the likelihood of unintentional utility line removal. Additionally, each receiving section 18 may be capable of receiving more than one cable, and the receiving sections 18 in a given row 10 of utility holders 12 may be of the same or different shape, number, and/or arrangement.

As shown in FIGS. 1, 3 and 4, the row 10 includes a plurality of holders 12. The holders 12 may be integrally formed or formed separately and joined together. The holders 12 may be generally modular; that is to say that the holders 12 may be constructed with generally standardized units and dimensions from one holder 12 to the next, such that they are generally interchangeable.

In one use of the holders 12, the row 10 may be mounted to a portion of a structure, such as at a joist, wall, beam, post, etc, with the holders 12 together to receive and hold a plurality of utility lines. Alternatively, the holders 12 may be separated into any desired numbers of holders 12 at optional score or break lines 20. The score lines 20 may be molded or cut into the bases 16 or provided in any other suitable manner.

The bases 16 optionally include apertures 22 for the passage of fasteners, such as screws or nails, for mounting. The apertures 22 may be spaced to accommodate standard fasteners, such as the staples traditionally used by electricians. The row 10 also optionally includes pre-inserted fasteners, e.g. nails 24.

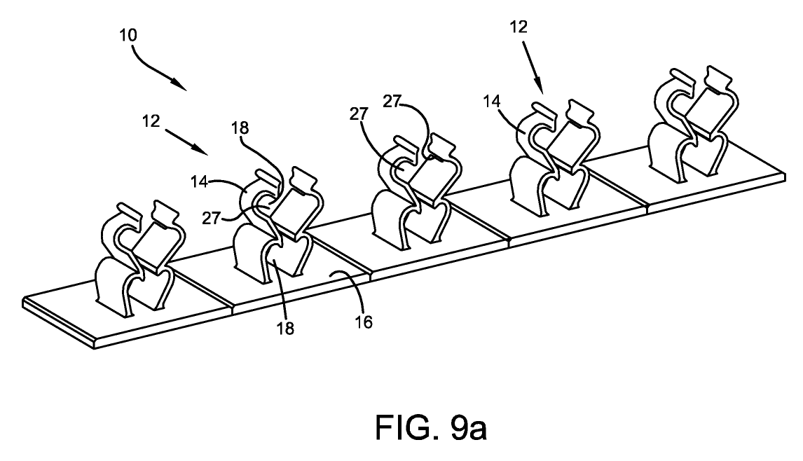

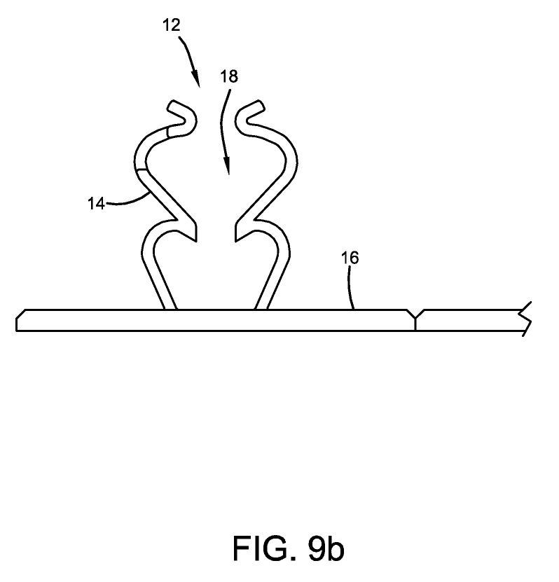

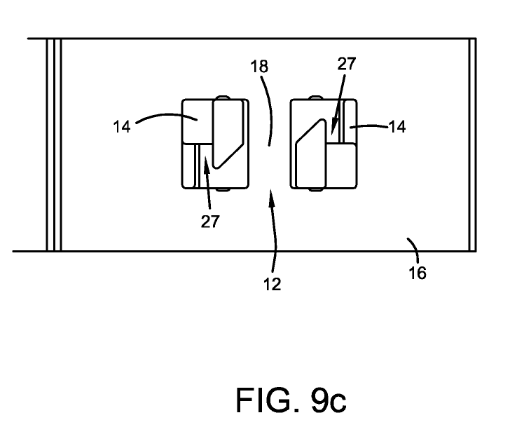

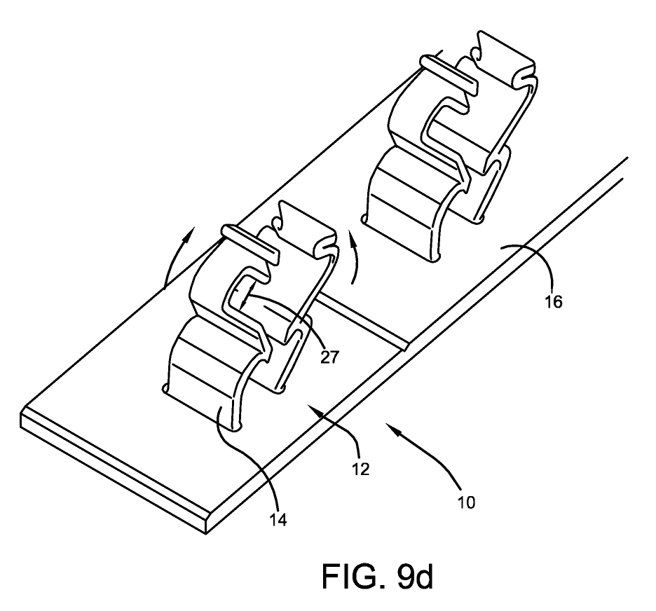

Upon installation, a utility line may be passed through or inserted into the receiving section 18. Alternatively, the utility line may be pressed or snapped into the receiving section 18. To this end, each finger 14 may include an optional tab 26 that serves to separate the pair of fingers 14 when pressure is applied to the tabs 26. Thus, in one installation, a utility line may be pressed against the tabs 26 and then pressed into the receiving section 18. In still other embodiments of the present invention, shown in FIGS. 9a-9d, the fingers 14 may have notched channels 27 that permit the fingers to be releasably secured to one another (as shown in FIG. 9d) so at to prevent the unintentional removal of the utility line.

The utility holders 12 may be formed from metal, plastic or any other suitable material and may be made by molding, pressing, stamping, cutting and welding or any other suitable method.

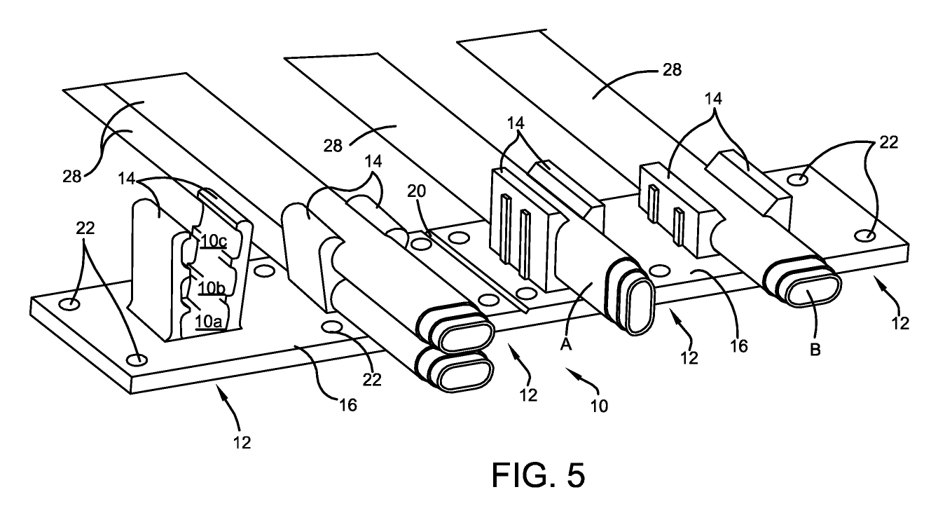

There is shown in FIG. 5 a row 10 of utilities holders 12 in accordance with another embodiment. Similar items are numbered with the same identifiers. This embodiment is generally similar to the embodiment of FIGS. 1-4 except that the row 10 is shown holding a variety of utility lines 28 in a variety of orientations.

There is shown in FIG. 5 at 18a, 18b and 18c three receiving sections for receiving a variety of size lines, such as 2 conductor or 3 conductor wire of the same or different gauges, respectively, or for further example 14 gauge, 12 gauge and 10 gauge of the same or different number conductors, respectively.

There is also, shown at A and B a utility line 28 in a vertical orientation A and a utility line 28 in a lateral orientation B.

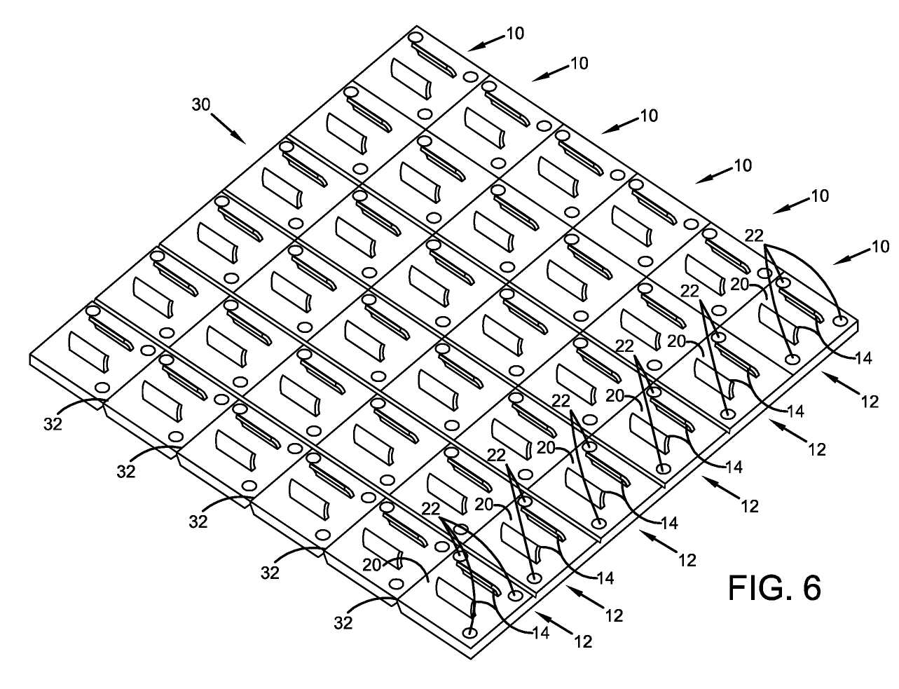

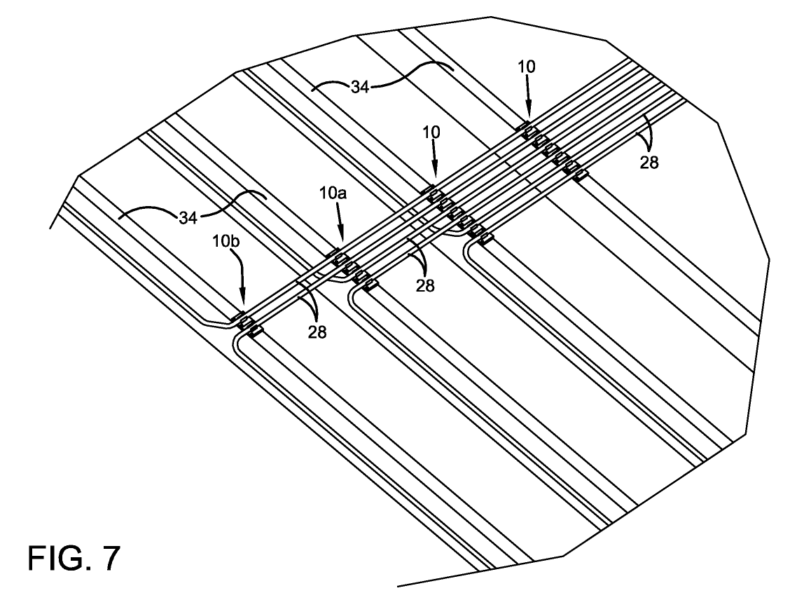

There is shown in FIG. 6 a plurality of rows 10 of utilities holders 12 in accordance with yet another embodiment. Similar items are numbered with the same identifiers. This embodiment is generally similar to the embodiments of FIGS. 1-5 except that the rows 10 are joined together to form an array 30 with the fingers 14 shaped to hold a single flat line. The array 30 includes six rows 10 each with six holders 12. The array 30 may however include any desired number of rows 10 or holders 12. The array 30 may be integrally formed or formed from separate holder 12 and/or rows 10 and joined together. For use, the array 30 may be separated in to separate rows 10 at optional second score or break lines 32. Each row 10 may then be mounted to a portion of a structure, such as at a joist, wall, beam, post, etc, with the holders 12 together to receive and hold a plurality of utility lines or alternatively, the holders 12 may then be separated into any desired numbers of holders 12 at the optional score or break lines 20. The second score lines 32 may be molded or cut into the array 30 provided in any other suitable manner.

There is shown in FIG. 7 one example of a utility line installation including a number of the utility holders 12 of FIG. 6. Rows 10 and partial rows 10a and 10b have been secured to joists 34. Utility lines 28 have been inserted into the holders 12.

Numerous embodiments have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

I/we claim:

1. A utility holder assembly comprising:
a holder comprising:
a first portion having at least two pairs of fingers defining at least two receiving sections wherein the receiving sections may be sized to accept utility lines;
a second portion having a base wherein the pairs of fingers extend from the base with the longitudinal axes of the receiving sections being substantially parallel.

2. The utility holder assembly of claim 1 further comprising:
a pair of tabs extending from the distal ends of each pair of fingers that serves to separate the pairs of fingers when force is applied to the tabs

3. The utility holder assembly of claim 1 further comprising:
at least one break line extending across the surface of the base substantially parallel to the longitudinal axes of the receiving sections, between the pairs of fingers, and penetrating a substantial amount into the surface of the base wherein the break line forms a weakened section of the base that can be used to separate the pairs of fingers into individual holding devices.

4. The utility holder assembly of claim 1 wherein the receiving sections are sized to accept electrical conduit.

5. The utility holder assembly of claim 1 wherein the receiving sections are sized to accept electrical cable.

6. The utility holder assembly of claim 1 wherein the receiving sections are sized to accept plumbing lines.

7. The utility holder assembly of claim 1 wherein the receiving sections are sized to accept HVAC lines.

8. The utility holder assembly of claim 1 wherein the holder is formed out of plastic.

9. The utility holder assembly of claim 1 wherein the holder is formed out of metal.

10. The utility holder assembly of claim 1 further comprising:
at least a pair of apertures located on the base.

11. The utility holder assembly of claim 10 further comprising:
at least a pair of fasteners inserted into the apertures.

12. The utility holder assembly of claim 11 wherein the fasteners are threaded fasteners.

13. A utility holder array comprising:
a first holder comprising:
a first portion having at least two pairs of fingers defining at least two receiving sections wherein the receiving sections may be sized to accept utility lines and with the longitudinal axes of the receiving sections being substantially parallel;
a second holder substantially similar to the first holder including the first portion; and,
a base wherein the fingers of the first and second holders extend in a substantially perpendicular manner from the base, additionally the longitudinal axes of the first holder and second holder receiving sections are aligned in substantially a straight line.

14. The utility holder assembly of claim 13 wherein the holder is formed out of plastic.

15. The utility holder assembly of claim 13 wherein the holder is formed out of metal.

16. The utility holder assembly of claim 13 further comprising:
at least one first break line extending across the surface of the base substantially parallel to the longitudinal axes of the receiving sections, between the pairs of fingers of the first holder, and penetrating a substantial amount into the surface of the base wherein the least one first break line forms a weakened section of the base that can be used to separate the pairs of fingers into individual holding devices; and,
at least one second break line extending across the surface of the base substantially perpendicular to the longitudinal axes of the receiving sections, between the first holder and the second holder and penetrating a substantial amount into the surface of the base wherein the least one second break line forms a weakened section of the base that can be used to separate the pairs of holders into individual holding devices

17. The utility holder assembly of claim 13 further comprising:
at least a first pair of apertures located on the base so that one aperture of the pair lies on one side of the first holder pair of fingers and the second aperture of the pair lies on the opposing side of the first holder pair of fingers; and,
at least a second pair of apertures located on the base so that one aperture of the pair lies on one side of the second holder pair of fingers and the second aperture of the pair lies on the opposing side of the second holder pair of fingers.

18. The utility holder assembly of claim 17 further comprising:
at least one fastener inserted into the first pair of apertures; and,
at least one fastener inserted into the second pair of apertures.

19. The utility holder assembly of claim 18 wherein the fasteners are threaded fasteners.

20. A method comprising the steps of:
(A) providing a holder comprising: (1) a first portion having at least two pairs of fingers defining at least two receiving sections wherein the receiving sections may be sized to accept utility lines; and, (2) a second portion having a base wherein the pairs of fingers extend from the base with the longitudinal axes of the receiving sections being substantially parallel;
(B) providing a second holder substantially similar to first holder including the first and second portions;
(C) attaching the base of the first holder to a structure;
(D) attaching the base of the second holder to a structure such that longitudinal axis of the first receiving section of the first holder and the longitudinal axis of the first receiving section of the second holder align in substantially a straight line;
(E) inserting a section of a first utility line into the first receiving section of the first holder;
(F) inserting a second continuous section of the first utility line into the first receiving section in the second holder that lies in a substantially straight line from the first holder;
(G) inserting a section of a second utility line into the second receiving section of the first holder; and,
(H) inserting a second continuous section of the second utility line into the second receiving section in the second holder that lies in a substantially straight line from the first holder.
